(19) United States
(12) Patent Application Publication
(10) Pub. No.: US 2019/0045840 A1
(43) Pub. Date: Feb. 14, 2019

(54) METHOD AND APPARATUS FOR COOLING SMOKE

(71) Applicant: RICHARD LEE GONZALEZ, CLIFTON, NJ (US)

(72) Inventor: RICHARD LEE GONZALEZ, CLIFTON, NJ (US)

(21) Appl. No.: 16/160,109

(22) Filed: Oct. 15, 2018

Related U.S. Application Data
(63) Continuation-in-part of application No. 16/114,165, filed on Aug. 27, 2018.

(51) Int. Cl. A24F 1/30; C09D 1/00; C09D 127/18

(52) U.S. Cl. CPC A24F 1/30; C09D 127/18; C09D 1/00

(57) ABSTRACT

A method and apparatus for cooling smoke by receiving smoke into a metallic chamber where the smoke is drawn in through a smoking stem and into a cooling liquid when the pressure applied to the surface of the cooling liquid is reduced. The present method and apparatus provide for reducing the adhesion of smoke particulate on an inner surface of the metallic chamber either by polishing, or by applying a non-stick coating to an inner surface of the metallic chamber.

### RELATED APPLICATIONS

The present application is a continuation-in-part of and claims priority to U.S. application Ser. No. 16/114,165 filed on Aug. 27, 2018 and entitled “METHOD AND SYSTEM FOR COOLING SMOKE”, by Richard Lee Gonzales, the text and figures of which are incorporated into this application in their entirety.

### BACKGROUND

People have been using tobacco for centuries. When tobacco was first introduced to Europe, it was thought to be a miracle substance. In fact tobacco is prescribed as medication for a wide variety of ailments, including severe cough. Modernly, medical science has demonstrated that the use of tobacco, rather than being a miracle substance, is a root cause of a wide variety of maladies.

Despite the now proven health hazards associated with tobacco use, many people continue to use tobacco. A common means of using tobacco is to inhale smoke created by burning of dry tobacco leaves. Many tobacco users recognize that inhaling the smoke is somewhat uncomfortable because the smoke is at a very elevated temperature, relative to the human body.

In order to reduce the temperature of tobacco smoke, many people now use a “bong”. A bong, also known as a water pipe, appears to have been first introduced by Erickson and described in the U.S. Pat. No. 4,216,785. Erickson described a structure that included a long mouthpiece. Penetrating the mouthpiece, according to Erikson, is a smoking stem. At the far tip of the smoking stem, tobacco was burned.

According to Erikson, the temperature of the smoke could be reduced by filling the elongated mouthpiece with a cooling liquid. To enhance the cooling process, frozen matter, for example ice, was also introduced into the cooling liquid. When a user would inhale at a top end of the mouthpiece, the pressure applied to the surface of the cooling liquid would be reduced. Thus, smoke from the smoking stem would be drawn into that portion of the mouthpiece that was filled with cooling liquid. The smoke would then be allowed to bubble up through the cooling liquid and then reached the user at a lower temperature.

Not long after Erickson introduced the concept of a water pipe, the design was further enhanced by increasing the volume at a bottom end of the mouthpiece. Many such designs resemble a flask, typically used in chemistry experiments, wherein the flask would have any elongated neck that would serve as the upper end of the mouthpiece. The increased volume at the bottom end of the mouthpiece would allow the use of a larger volume of cooling liquid. By increasing the volume of the cooling liquid, a tobacco user could enjoy cold smoke for a much longer duration of time. In the water pipe described by Erickson, the volume of cooling liquid was limited by the diameter of the mouthpiece. The amount of cooling liquid that could be introduced into Erickson's water pipe was thereby limited, and resulted in the need to frequently replace the cooling liquid.

To improve the efficacy of the cooling liquid, Gonzalez, in pending application Ser. No. 16/114,165 filed on Aug. 27, 2018, teaches the use of a thermal barrier, which substantially reduces the amount of heat that enters the cooling chamber from the ambient environment. The use of a thermal barrier clearly provides longer periods of time during which the bong can be used before replacing the water. However, the thermal barrier may be more susceptible to accumulation of smoke particulate.

### BRIEF DESCRIPTION OF THE DRAWINGS

Several alternative embodiments will hereinafter be described in conjunction with the appended drawings and figures, wherein like numerals denote like elements, and in which:

FIG. 1 is a flow diagram that illustrates one example method for cooling smoke;

FIG. 2 is a flow diagram that depicts one alternative method for reducing the adhesion of smoke particulate on an inner surface of the metallic chamber;

FIG. 3 is a flow diagram that depicts one alternative method whereby a non-stick coating is applied to the inner surface of the metallic chamber in order to reduce adhesion of smoke particulate;

FIGS. 4, 4A and 5 are flow diagrams that depict various alternative methods for applying a non-stick surface to the inner surface of the metallic chamber;

FIG. 6 is a flow diagram that depicts one example method for reducing pressure applied to a surface of a cooling liquid;

FIG. 7 is a flow diagram that depicts one alternative example method for reducing adhesion of smoke particulate on the inner surface of a metallic pressure reduction path;

FIG. 8 is a flow diagram that depicts one alternative example method wherein reducing adhesion of smoke particulate on an inner surface of the metallic pressure reduction path is accomplished by applying a non-stick coating to said inner surface;

FIGS. 8A, 9 and 10 are flow diagrams that depict alternative example methods for reducing adhesion of smoke particulate on an inner surface of the metallic pressure reduction path;

FIG. 11 is a pictorial diagram of one example embodiment of a smoking apparatus;

FIG. 12 is a pictorial diagram that illustrates one alternative example embodiment of a metallic chamber; and

FIG. 13 is a pictorial diagram that illustrates alternative example embodiments of a pressure reduction path.

### DETAILED DESCRIPTION

In the interest of clarity, several example alternative methods are described in plain language. Such plain language descriptions of the various steps included in a particular method allow for easier comprehension and a more fluid description of a claimed method and its application. Accordingly, specific method steps are identified by the term “step” followed by a numeric reference to a flow diagram presented in the figures, e.g. (step 5). All such method “steps” are intended to be included in an open-ended enumeration of steps included in a particular claimed method. For example, the phrase “according to this example method, the item is processed using A” is to be given the meaning of “the present method includes step A, which is used to process the item”. All variations of such natural language descriptions of method steps are to be afforded this same open-ended enumeration of a step included in a particular claimed method.

Unless specifically taught to the contrary, method steps are interchangeable and specific sequences may be varied according to various alternatives contemplated. Accordingly, the claims are to be construed within such structure. Further, unless specifically taught to the contrary, method steps that include the phrase “ . . . comprises at least one or more of A, B, and/or C . . . ” means that the method step is to include every combination and permutation of the enumerated elements such as “only A”, “only B”, “only C”, “A and B, but not C”, “B and C, but not A”, “A and C, but not B”, and “A and B and C”. This same claim structure is also intended to be open-ended and any such combination of the enumerated elements together with a non-enumerated element, e.g. “A and D, but not B and not C”, is to fall within the scope of the claim. Given the open-ended intent of this claim language, the addition of a second element, including an additional of an enumerated element such as “2 of A”, is to be included in the scope of such claim. This same intended claim structure is also applicable to apparatus and system claims.

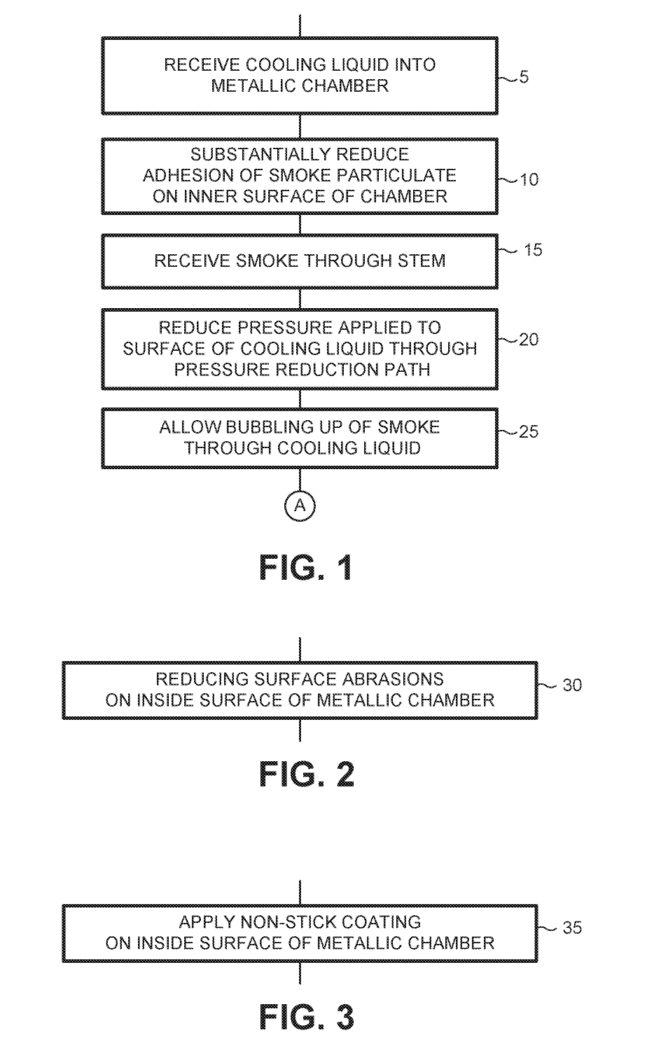

FIG. 1 is a flow diagram that illustrates one example method for cooling smoke. According to this example method, cooling smoke is accomplished by receiving a cooling liquid into a metallic chamber (step 5). According to this example method, a step is provided for substantially reducing the adhesion of the smoke particulate on an inner surface of the metallic chamber (step 10). This method further includes a step for receiving smoke through a smoking stem (step 15). It should be appreciated that, according to various illustrative use cases, the smoking stem protrudes into a cooling liquid when the present method is practiced. In order to receive the smoke through the smoking stem, this present method further includes a step for reducing the pressure applied to a surface of the cooling liquid through a pressure reduction path (step 20). As pressure is reduced upon the surface of the liquid introduced into the metallic chamber, smoke is drawn through the smoking stem and is allowed to bubble up through the cooling liquid, (step 25) as provided for in an additional step of the present method.

FIG. 2 is a flow diagram that depicts one alternative method for reducing the adhesion of smoke particulate on an inner surface of the metallic chamber. According to this example alternative method, reducing, in a substantial manner, adhesion of smoke particulate on an inner surface of the metallic chamber comprises reducing surface abrasions on the inside surface of the metallic chamber (step 30). It should be appreciated that, according to various illustrative use cases of the present method, abrasions is accomplished by polishing the inside surface of the metallic chamber.

FIG. 3 is a flow diagram that depicts one alternative method whereby a non-stick coating is applied to the inner surface of the metallic chamber in order to reduce adhesion of smoke particulate. It should likewise be appreciated that, according to one alternative example method, substantially reducing the adhesion of smoke particulate on an inner surface of the metallic chamber comprises applying a non-stick coating onto the inside surface of the metallic chamber (step 35). It should be appreciated that methods for application of a non-stick coating onto a metal surface are well known and are not described here.

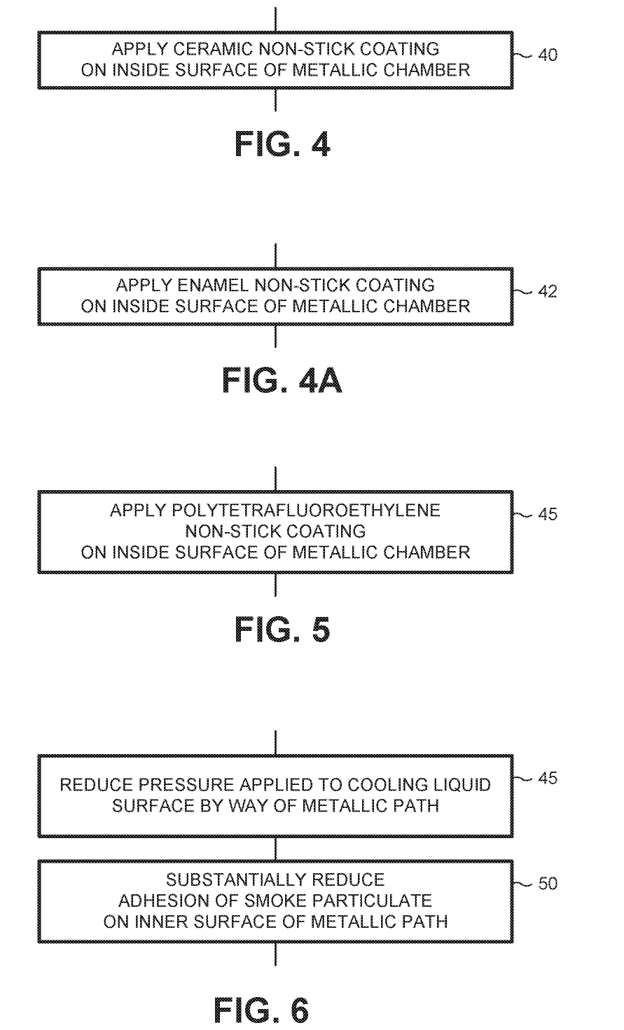

FIGS. 4, 4A and 5 are flow diagrams that depict various alternative methods for applying a non-stick surface to the inner surface of the metallic chamber. It should be appreciated that, as provided for in one alternative example method, applying a non-stick coating comprises applying a ceramic-based non-stick coating to the inner surface of the metallic chamber (step 40). In an alternative example method, applying a non-stick coating comprises applying an enamel based non-stick coating on the inside of a metallic chamber (step 42). And in yet another alternative example method, a polytetrafluoroethylene based non-stick coating is applied on the inside surface of the metallic chamber (step 45). It should be appreciated that there are yet other types of non-stick coatings and the examples presented here are not intended to limit the scope of the claims appended hereto.

FIG. 6 is a flow diagram that depicts one example method for reducing pressure applied to a surface of a cooling liquid. According to one illustrative use case, the present method provides for introducing a cooling liquid into the metal chamber. In order to reduce the pressure applied to a surface of the cooling liquid, according to this example method, a step is included for reducing the pressure applied to the surface of the cooling liquid through a metallic pressure reduction path (step 45) and also substantially reducing the adhesion of smoke particulate on an inner surface of the metallic pressure reduction path (step 50).

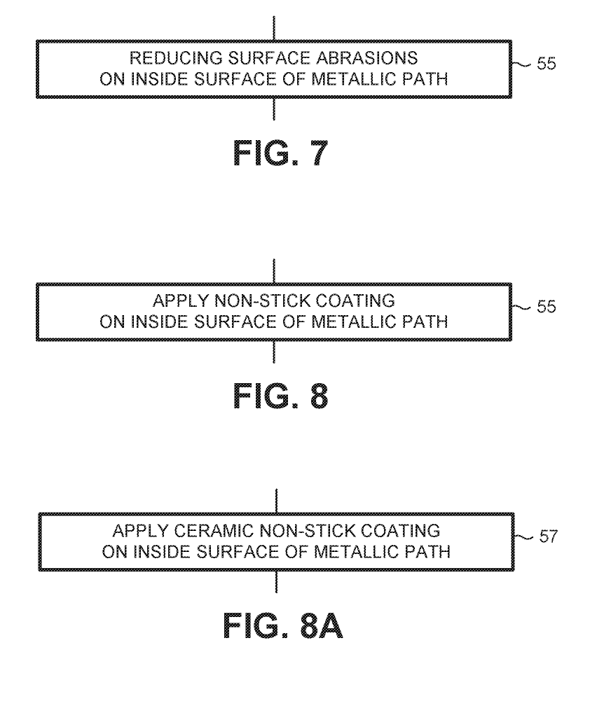

FIG. 7 is a flow diagram that depicts one alternative example method for reducing adhesion of smoke particulate on the inner surface of a metallic pressure reduction path. It should be appreciated that, according to one alternative example method, reducing adhesion of smoke particulate on an inner surface of a metallic pressure reduction path comprises reducing the surface abrasions on the inside surface of said metallic pressure reduction path (step 55). It should likewise be appreciated that this method, according to various illustrative use cases, is accomplished by polishing the inside surface of the pressure reduction path.

FIG. 8 is a flow diagram that depicts one alternative example method wherein reducing adhesion of smoke particulate on an inner surface of the metallic pressure reduction path is accomplished by applying a non-stick coating to said inner surface. Accordingly, such alternative method comprises such a step (step 60) for applying a non-stick coating to said inner surface.

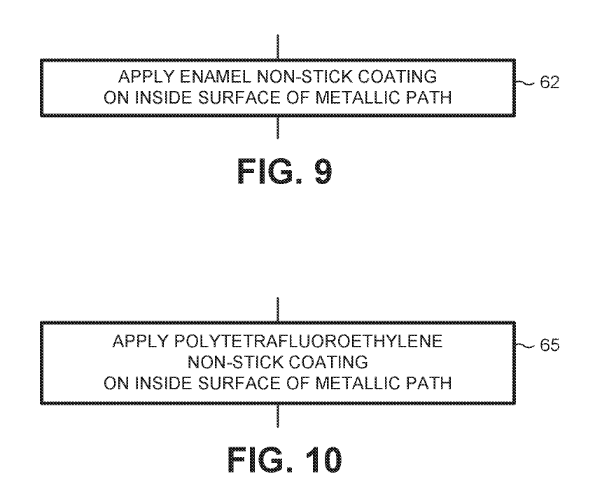

FIGS. 8A, 9 and 10 are flow diagrams that depict alternative example methods for reducing adhesion of smoke particulate on an inner surface of the metallic pressure reduction path. As heretofore described, one alternative example method comprises a step for applying a non-stick coating onto the inside surface of a metallic pressure reduction path. According to one alternative example method, application of a non-stick coating onto the inside surface of a metallic path comprises applying an ceramic-based non-stick coating on the inside surface of the metallic path (step 62). According to one alternative example methods, application of a non-stick coating onto the inside surface of a metallic pressure reduction path comprises applying an enamel based non-stick coating on the inside surface of the metallic path (step 62). According to yet another alternative example method, application of a non-stick coating onto the inside surface of a metallic pressure reduction path comprises applying a polytetrafluoroethylene-based non-stick coating (step 65) to the inside surface of the metallic pressure reduction path. It should likewise be appreciated that various types of non-stick coatings, according to various illustrative use cases, are applied to the inside surface of the metallic pressure reduction path and the examples set forth herein are not intended to limit the scope of the claims appended hereto.

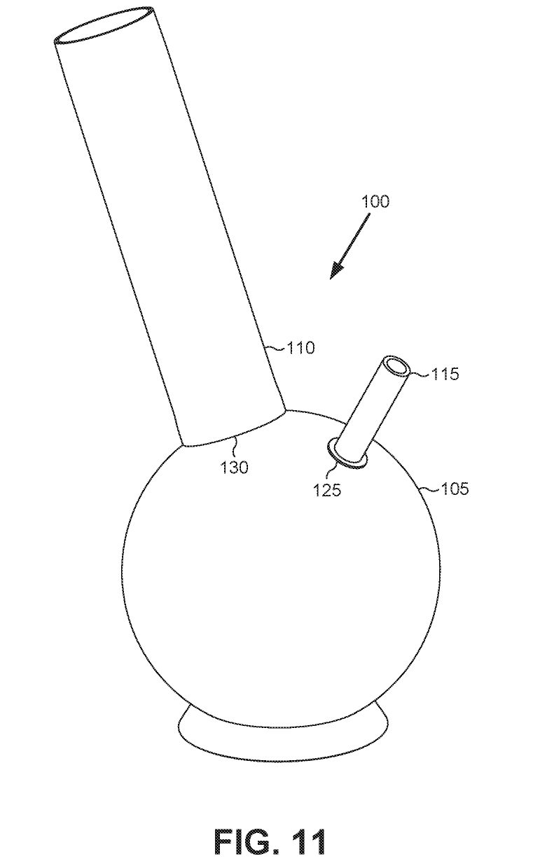

FIG. 11 is a pictorial diagram of one example embodiment of a smoking apparatus. According to this example embodiment, the smoking apparatus comprises a metallic chamber 105, a metallic pressure reduction path 110, and a metallic stem. As depicted in the figure, metallic pressure reduction path 110 comprises a substantially cylindrical member that is attached 130 to the metallic chamber 105. It should be appreciated that, according to various alternative example embodiments, the metallic pressure reduction path 110 takes on various shapes and need not be cylindrical. Accordingly, any particular type of shape herein described is set forth for the purpose of illustrating one alternative example embodiment and is not intended to limit the scope of the claims appended hereto.

It should likewise be appreciated that, according to this example embodiment, the metallic stem 115 protrudes through an opening 125 disposed on an upper portion of the metallic chamber 105.

According to this example embodiment, the metallic chamber 105 includes an inner surface that is treated to reduce adhesion of a small particle. Likewise, the metallic pressure reduction path 110 also includes an inner surface which is analogously treated to reduce adhesion of a small particle. The metallic stem 115 also includes an inner surface.

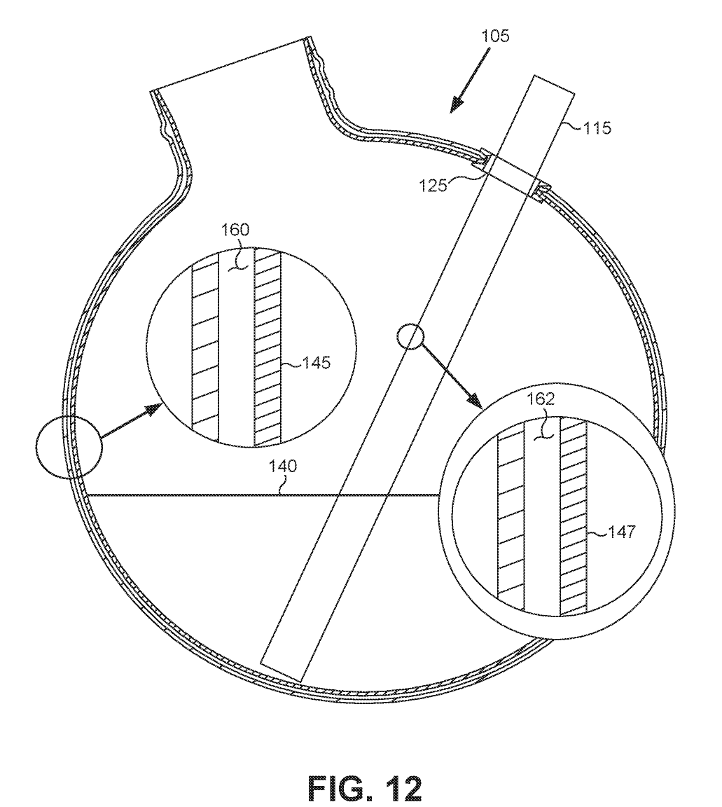

FIG. 12 is a pictorial diagram that illustrates one alternative example embodiment of a metallic chamber. According to this alternative example embodiment, the metallic chamber 105 includes an inner surface 160. The inner surface 160, according to this alternative example embodiment comprises a polished surface in order to treat said inner surface for the purpose of reducing adhesion of a small particle.

According to yet another alternative example embodiment, the inner surface 160 of the metallic chamber 105 by applying a non-stick coating 145 to said surface. It should likewise be appreciated that the application of a non-stick coating to a metal surface is accomplished by well-known techniques and is not discussed further herein. It should likewise be appreciated that, according to one alternative example embodiment, the non-stick coating 145 comprises at least one or more of a ceramic-based non-stick coating, an enamel-based non-stick coating and/or a polytetrafluoroethylene-based anti-stick coating.

FIG. 12 also illustrates that the metallic stem 115 also includes an inner surface 162. According to one alternative example embodiment, the inner surface 162 of the metallic stem 115 comprises a polished surface in order to reduce adhesion of a small particle. In yet another alternative example embodiment, the internal surface 162 of the stem 115 is treated by application of a non-stick coating 147. It should likewise be appreciated that, according to one alternative example embodiment, the non-stick coating 147 comprises at least one or more of a ceramic-based non-stick coating, an enamel-based non-stick coating and/or a polytetrafluoroethylene-based anti-stick coating.

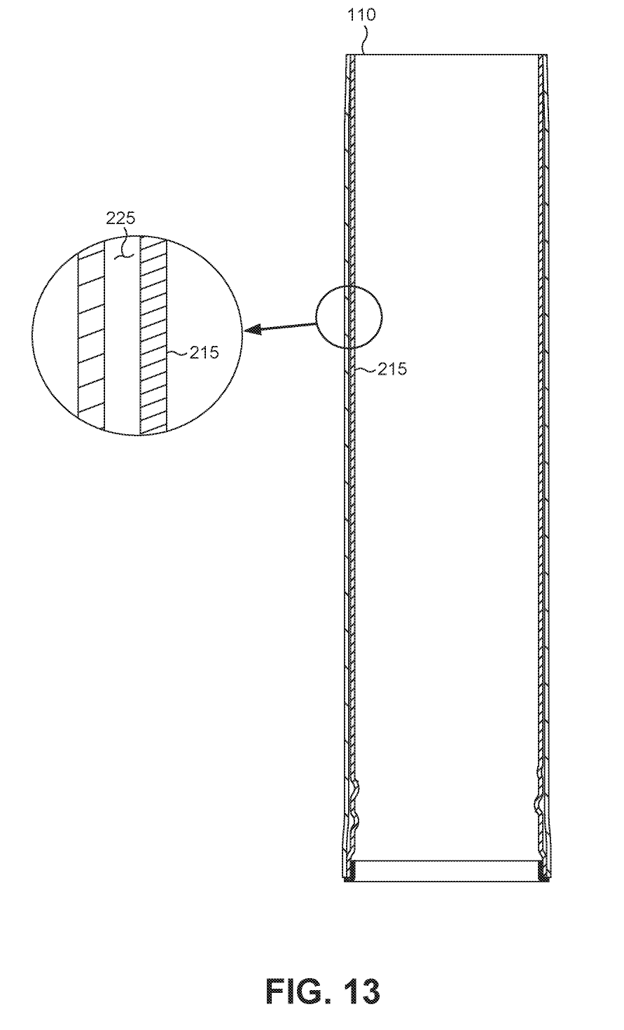

FIG. 13 is a pictorial diagram that illustrates alternative example embodiments of a pressure reduction path. According to one alternative example embodiment, the pressure reduction path includes an inner surface 225. It should be appreciated that, according to one alternative example embodiment, the inner surface 225 comprises a polished surface in order to reduce adhesion of a small particle. According yet another alternative example embodiment, the internal surface 225 is treated by application of an anti-stick coating 215. Accordingly, one alternative example embodiment of a pressure reduction path 110 includes such anti-stick coating 215 apply to the inner surface 225. And in yet another alternative example embodiment, the non-stick coating 215 apply to the inner surface 225 comprises at least one or more of a ceramic-based non-stick coating, an enamel-based non-stick coating and/or a polytetrafluoroethylene-based anti-stick coating.

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents. It should likewise be appreciated that, as used within the specification and claims set forth herein, the terms anti-stick coating and non-stick coating are used interchangeably and are not to be construed as limitations to the claims appended hereto.

What is claimed is:

1. A method for cooling smoke:
receiving a cooling liquid into a metallic chamber;
substantially reducing the adhesion of smoke particulate on an inner surface of the metallic chamber;
receiving smoke through a stem, said stem including an end that protrudes into the cooling liquid;
reducing the pressure applied to a surface of the cooling liquid through a pressure reduction path; and
allowing the smoke to bubble up through the cooling liquid when the pressure applied to the surface is reduced.

2. The method of claim 1 wherein substantially reducing the adhesion of smoke particulate on an inner surface of the metallic chamber comprises reducing the surface aberrations on the inside surface of the metallic chamber.

3. The method of claim 1 wherein substantially reducing the adhesion of smoke particulate on an inner surface of the metallic chamber comprises applying a ceramic-based anti-stick coating to the inner surface of the metallic chamber.

4. The method of claim 1 wherein substantially reducing the adhesion of smoke particulate on an inner surface of the metallic chamber comprises applying a enamel-based anti-stick coating to the inner surface of the metallic chamber

5. The method of claim 1 wherein substantially reducing the adhesion of smoke particulate on an inner surface of the metallic chamber comprises applying a polytetrafluoroethylene-based anti-stick coating to the inner surface of the metallic chamber.

6. The method of claim 1 wherein reducing the pressure applied to a surface of the cooling liquid through a pressure reduction path comprises:
reducing the pressure applied to a surface of the cooling liquid through a metallic pressure reduction path; and
substantially reducing the adhesion of smoke particulate on an inner surface of the metallic pressure reduction path.

7. The method of claim 6 wherein substantially reducing the adhesion of smoke particulate on an inner surface of the metallic pressure reduction path comprises reducing the surface aberrations on the inside surface of the metallic chamber.

8. The method of claim 6 wherein substantially reducing the adhesion of smoke particulate on an inner surface of the metallic pressure reduction path comprises applying a ceramic-based anti-stick coating to the inner surface of the metallic pressure reduction path.

9. The method of claim 6 wherein substantially reducing the adhesion of smoke particulate on an inner surface of the metallic pressure reduction path comprises applying an enamel-based anti-stick coating to the inner surface of the metallic pressure reduction path.

10. The method of claim 6 wherein substantially reducing the adhesion of smoke particulate on an inner surface of the metallic pressure reduction path comprises applying a polytetrafluoroethylene-based anti-stick coating to the inner surface of the metallic pressure reduction path.

11. A smoking apparatus comprising:
metallic chamber for receiving a cooling liquid wherein the metallic chamber includes an inner surface that is treated to reduce adhesion of a smoke particle;
metallic pressure reduction path for reducing gaseous pressure on the inside of the metallic chamber, said metallic pressure reduction path having an inner surface treated to reduce adhesion of a smoke particle; and
metallic stem for receiving smoke into the metallic chamber, said stem protruding through a wall of the metallic chamber and into a portion of the metallic chamber that would contain the cooling liquid and wherein the stem includes an inner surface.

12. The smoking apparatus of claim 11 wherein the inner surface of the metallic chamber is polished to reduce surface abrasions.

13. The smoking apparatus of claim 11 further including an anti-stick coating applied to the inner surface of the metallic chamber.

14. The smoking apparatus of claim 11 further including an anti-stick coating applied to the inner surface of the metallic chamber, said anti-stick coating comprising at least one or more of a ceramic-based anti-stick coating, an enamel-based anti-stick coating and/or a polytetrafluoroethylene-based anti-stick coating.

15. The smoking apparatus of claim 11 further including an anti-stick coating applied to the inner surface of the metallic pressure reduction path.

16. The smoking apparatus of claim 11 further including an anti-stick coating applied to the inner surface of the metallic pressure reduction path, said anti-stick coating comprising at least one or more of a ceramic-based anti-stick coating, an enamel-based anti-stick coating and/or a polytetrafluoroethylene-based anti-stick coating.

17. The smoking apparatus of claim 11 wherein the inner surface of the metallic stem is treated to reduce adhesion of a smoke particle.

18. The smoking apparatus of claim 11 wherein the inner surface of the metallic stem is polished to reduce adhesion of a smoke particle.

19. The smoking apparatus of claim 11 further including an anti-stick coating applied to the inner surface of the metallic stem.

20. The smoking apparatus of claim 11 further including an anti-stick coating applied to the inner surface of the metallic stem said anti-stick coating comprising one or more of a ceramic-based anti-stick coating, an enamel-based anti-stick coating and/or a polytetrafluoroethylene-based anti-stick coating.
